(19) United States
(12) Patent Application Publication
(10) Pub. No.: US 2026/0113551 A1
(43) Pub. Date: Apr. 23, 2026

(54) DYNAMIC READ-OUT CIRCUITRY FOR LIGHT-SENSING PIXEL BASED ON LIGHT INTENSITY

(71) Applicant: STMicroelectronics International N.V., Geneva (CH)

(72) Inventor: Jeffrey M. RAYNOR, Edinburgh (GB)

(21) Appl. No.: 18/924,081

(22) Filed: Oct. 23, 2024

(51) Int. Cl. H04N 25/78; H04N 25/706

(52) U.S. Cl. CPC H04N 25/78; H04N 25/706

(57) ABSTRACT

An example light-sensing pixel, an ambient light sensor, and an electronic device comprising an ambient light sensor configured to generate a light intensity value based on light intensity are provided. The light-sensing pixel includes light sensing circuitry, high light read-out circuitry, low light read-out circuitry, and a switching device. The high light read-out generates a light intensity value based on a current of the read-out electrical output generated by the light sensing circuitry. The low light read-out circuitry generates a light intensity value based on a voltage of the read-out electrical output. The switching device electrically disconnects the high light read-out circuitry from the light sensing circuitry when the light intensity value is less than a low light intensity value threshold, and electrically connects the high light read-out circuitry to the light sensing circuitry when the light intensity value is greater than a high light intensity value threshold.

### TECHNOLOGICAL FIELD

Embodiments of the present disclosure relate generally to light-sensing pixels, and more particularly, to read-out circuitry configured to generate a light intensity value based on an electrical output of light-sensing circuitry.

### BACKGROUND

Many electronic devices may adjust settings based on the ambient light in a surrounding environment. For example, a digital camera may adjust capture settings or a digital display may adjust brightness settings based on ambient light in the surrounding environment. A common technique is to measure the ambient light in an environment and then adjust the setting of the electronic device based on the ambient light measurement.

Applicant has identified many technical challenges and difficulties associated with ambient light measurement, particularly in low light environments. Through applied effort, ingenuity, and innovation, Applicant has solved problems related to measuring ambient light in a low light environment by developing solutions embodied in the present disclosure, which are described in detail below.

### BRIEF SUMMARY

Various embodiments are directed to an example light-sensing pixel, an ambient light sensor, and an electronic device comprising an ambient light sensor configured to generate a light intensity value based on light intensity. A light-sensing pixel, comprising light sensing circuitry, high light read-out circuitry, low light read-out circuitry, and a switching device. The light sensing circuitry configured to generate a read-out electrical output based on a quantity of photons received at a photodiode device. The high light read-out circuitry configured to generate a light intensity value based on a current of the read-out electrical output. The low light read-out circuitry electrically connected to the read-out electrical output and configured to generate the light intensity value based on a voltage of the read-out electrical output. The switching device configured to electrically disconnect the first read-out circuitry from the light sensing circuitry based on the light intensity value.

In some embodiments, the high light read-out circuitry comprises an operational amplifier and an analog-to-digital converter.

In some embodiments, the read-out electrical output is electrically connected to an inverting input of the operational amplifier.

In some embodiments, the light sensing circuitry comprises a three transistor (3T) pixel architecture.

In some embodiments, the low light read-out circuitry determines the voltage of the read-out electrical output by comparison to a voltage ramp.

In some embodiments, the low light read-out circuitry comprises a comparator and a memory device.

In some embodiments, an inverting input of the comparator is electrically connected to the read-out electrical output and a non-inverting input is electrically connected to the voltage ramp.

In some embodiments, the voltage ramp comprises a voltage divided derivative of a system ramp voltage.

In some embodiments, the voltage divided derivative of the system ramp voltage is determined locally at the low light read-out circuitry.

In some embodiments, the voltage ramp comprises a shifted derivative of the system ramp voltage.

In some embodiments, the low light read-out circuitry is electrically connected to an anode of the photodiode device.

An example ambient light sensor is further provided. The example ambient light sensor comprising a plurality of light-sensing pixels, and pixel accumulation circuitry. Within the plurality of light-sensing pixels, each light sensing pixel comprises light sensing circuitry, high light read-out circuitry, low light read-out circuitry, and a switching device. The light sensing circuitry configured to generate a read-out electrical output based on a quantity of photons received at a photodiode device. The high light read-out circuitry configured to generate a light intensity value based on a current of the read-out electrical output. The low light read-out circuitry configured to generate the light intensity value based on a voltage of the read-out electrical output. The switching device configured to electrically disconnect the first read-out circuitry from the light sensing circuitry based on the light intensity value. The pixel accumulation circuitry is configured to generate an ambient light value based on the light intensity value of each light-sensing pixel of the plurality of light-sensing pixels.

In some embodiments, the high light read-out circuitry comprises an operational amplifier and an analog-to-digital converter.

In some embodiments, the read-out electrical output is electrically connected to an inverting input of the operational amplifier.

In some embodiments, the light sensing circuitry comprises a three transistor (3T) pixel architecture.

In some embodiments, the low light read-out circuitry determines the voltage of the read-out electrical output by comparison to a voltage ramp.

In some embodiments, the low light read-out circuitry comprises a comparator and a memory device.

In some embodiments, an inverting input of the comparator is electrically connected to the read-out electrical output and a non-inverting input is electrically connected to the voltage ramp.

In some embodiments, the low light read-out circuitry is electrically connected to an anode of the photodiode device.

An electronic device comprising a housing, a display screen, and an ambient light sensor. The display screen attached to the housing, the display screen comprising a first side configured to emit transmitted light via a plurality of display pixels into an external environment. The ambient light sensor disposed within the housing, opposite the first side of the display screen, the ambient light sensor comprising a plurality of light sensing pixels and pixel accumulation circuitry. The plurality of light-sensing pixels, each comprising light sensing circuitry, high light read-out circuitry, low light read-out circuitry, and a switching device. The light sensing circuitry configured to generate a read-out electrical output based on a quantity of photons received at a photodiode device. The high light read-out circuitry configured to generate a light intensity value based on a current of the read-out electrical output. The low light read-out circuitry configured to generate the light intensity value based on a voltage of the read-out electrical output. The switching device configured to electrically disconnect the first read-out circuitry from the light sensing circuitry based on the light intensity value. The pixel accumulation circuitry is configured to generate an ambient light value based on the light intensity value of each light-sensing pixel of the plurality of light-sensing pixels.

A method for generating a light intensity value at an ambient light sensor is further provided. The method comprising: generating, at light sensing circuitry, a read-out electrical output based on a quantity of photons received at a photodiode device. The method further comprising determining a switching state of a switching device based on the quantity of photons received at the photodiode device. The method further comprising updating the switching device based on the switching state. In some embodiments, in a first switching state, the first read-out circuitry is electrically connected to the light sensing circuitry and the light intensity value is generated by the first read-out circuitry. In some embodiments, in a second switching state, the first read-out circuitry is electrically disconnected from the light sensing circuitry and the light intensity value is generated by the second read-out circuitry.

### BRIEF DESCRIPTION OF THE DRAWINGS

Reference will now be made to the accompanying drawings. The components illustrated in the figures may or may not be present in certain embodiments described herein. Some embodiments may include fewer (or more) components than those shown in the figures in accordance with an example embodiment of the present disclosure.

FIG. 1 illustrates an example light-sensing pixel comprising read-out circuitry.

FIG. 2 illustrates an example block diagram of a light-sensing pixel in accordance with an example embodiment of the present disclosure.

FIG. 3 illustrates an example flow chart for determining a read-out mode at a light-sensing pixel in accordance with an example embodiment of the present disclosure.

FIG. 4 illustrates an example embodiment of a light-sensing pixel in accordance with an example embodiment of the present disclosure.

FIG. 5 illustrates an example embodiment of a light-sensing pixel comprising a voltage ramp shifting capacitor in accordance with an example embodiment of the present disclosure.

FIG. 6 depicts an example graph illustrating determination of a read-out electrical output voltage by comparison to a voltage ramp in accordance with an example embodiment of the present disclosure.

FIG. 7 illustrates an example signal diagram determining a read-out electrical output voltage by comparison to a voltage ramp in accordance with an example embodiment of the present disclosure.

FIG. 8 illustrates an example embodiment of a light-sensing pixel comprising low light read-out circuitry electrically connected to an anode of the photodiode device in accordance with an example embodiment of the present disclosure.

FIG. 9 illustrates an example ambient light sensor comprising a plurality of light-sensing pixels in accordance with an example embodiment of the present disclosure.

FIG. 10 illustrates an example electronic device comprising an ambient light sensor in accordance with an example embodiment of the present disclosure.

### DETAILED DESCRIPTION

Example embodiments will be described more fully hereinafter with reference to the accompanying drawings, in which some, but not all embodiments of the inventions of the disclosure are shown. Indeed, embodiments of the disclosure may be embodied in many different forms and should not be construed as limited to the embodiments set forth herein; rather, these embodiments are provided so that this disclosure will satisfy applicable legal requirements. Like numbers refer to like elements throughout.

Various example embodiments address technical problems associated with noise levels in light-sensing pixels comprising ambient light sensors, particularly in low light environments. As understood by those of skill in the field to which the present disclosure pertains, there are numerous example scenarios in which an ambient light sensor may benefit from increased accuracy in low light environments.

For example, many electronic devices may adjust settings based on the ambient light in a surrounding environment. For example, a digital camera may adjust capture settings based on ambient light in the environment in which an image is captured. Similarly, a mobile device may adjust the brightness of a digital display based on the ambient light in the display environment. A common technique of many of these devices is to measure the intensity of ambient light in the surrounding environment and then adjust the relevant setting based on the ambient light measurement.

Enabling dynamic setting adjustment requires continuous measurement of the ambient light of the surrounding environment. In addition, in some embodiments, the ambient light sensor may be required to operate in low light conditions. For example, the ambient light sensor may be placed under a digital display. In an instance in which the ambient light sensor is placed under the digital display the amount of ambient light received at the ambient light sensor may be greatly reduced. In addition, the ambient light received may be affected by the light generated by the digital display.

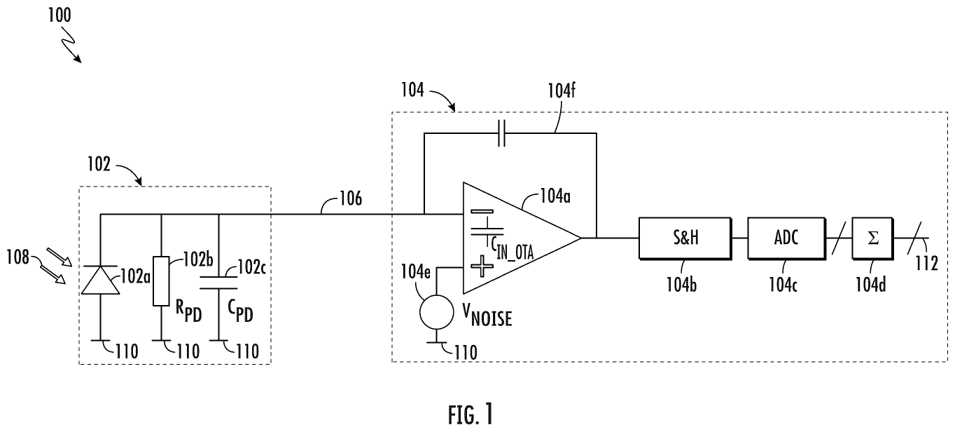

Adequate performance of an ambient light sensor in ultra low light conditions requires reduction of noise in the sensing and read-out circuitry. Referring now to FIG. 1, a standard light-sensing pixel 100 is provided. As depicted in FIG. 1, the example standard light-sensing pixel 100 includes light sensing circuitry 102 configured to generate an electrical output 106 based on the number of photons 108 encountering the photodiode device 102a of the light sensing circuitry 102. The electrical output 106 is transmitted to the electrically connected read-out circuitry 104 which is further configured to generate a light intensity value 112 based on the electrical output 106.

As depicted in FIG. 1, the example light sensing circuitry 102 includes a photodiode device 102a. The photodiode device 102a comprises any device configured to convert photons received at a surface of the photodiode device 102a into an electric current. A photodiode device 102a may comprise a photodiode, complementary metal-oxide-semiconductor (CMOS) photodiode, single photon avalanche diode (SPAD), photodetector, or similar device. In an instance in which photons impact the photodiode device 102a, it excites electrons within the photodiode device 102a, creating an electron-hole pair. These moving charge carriers generate an output current (e.g., electrical output 106) based on the number of photons impacting the photodiode device 102a. The circuit diagram of FIG. 1 further illustrates a photodiode resistance 102b and a photodiode capacitance 102c. The photodiode resistance 102b represents parasitic leakage through the PN junction of the photodiode device 102a. Similarly, the photodiode capacitance 102c represents a capacitance associated with the PN junction of the photodiode device 102a.

As further depicted in FIG. 1, the electrical output 106 generated by the photodiode device 102a is transmitted to the read-out circuitry 104. The read-out circuitry 104 comprises any circuitry including passive electrical components configured to generate an output voltage (e.g., light intensity value 112) based on the current of the electrical output 106 received from the light sensing circuitry 102. As depicted in FIG. 1, the read-out circuitry 104 is operating in a current read-out mode, meaning the current of the electrical output 106 is integrated into a voltage.

As further depicted in FIG. 1, the read-out circuitry 104 includes an operational amplifier 104a in a charge integration configuration. The operational amplifier 104a includes an inverting input port (−), a non-inverting input port (+), and an output port. The output port is electrically connected to the inverting port (−) on an electrical path including a feedback capacitor 104f. The operational amplifier 104a is configured to receive the electrical output 106 from the light sensing circuitry 102 at the inverting port (−). Thus, the output of the operational amplifier 104a corresponds to the area under the electrical output 106 signal over time. For example, if the current of the electrical output 106 remains constant, then the output from the operational amplifier 104a increases at a constant rate (slope).

The read-out circuitry 104 further includes a sample and hold circuit 104b, analog-to-digital converter 104c, and summation circuitry 104d all configured to generate a digital output (e.g., light intensity value 212) based on the output from the operational amplifier 104a.

In addition, as depicted in FIG. 1, the operational amplifier 104a acts as a non-inverting amplifier. Thus, any noise (e.g., noise 104e) received at the non-inverting input is amplified, causing inaccuracies in the light intensity value 112.

Noise may be introduced at various points within the standard light-sensing pixel 100. For example, various capacitances within the light sensing circuitry 102 and read-out circuitry 104 may introduce noise into the light intensity value 112. Noise may have a significant impact on the accuracy of an electronic device relying on the light intensity value 112 generated by the standard light-sensing pixel 100, such as, an ambient light sensor. Inaccuracies due to noise may be exacerbated in low light environments. Capacitances in the light sensing circuitry 102 and read-out circuitry 104 are significant contributors to noise in the standard light-sensing pixel 100. For example, the photodiode capacitance 102c, the input terminal capacitance (C_{IN_OTA}) of the operational amplifier 104a and the integration capacitance of the feedback capacitor 104f may all play a role in the impact of noise on a generated light intensity value 112. Specifically, high photodiode capacitance 102c and input terminal capacitance (C_{IN_OTA}) and low integration capacitance of the feedback capacitor 104f may significantly increase the noise levels in the standard light-sensing pixel 100.

Some previous example light-sensing pixels have reduced the photodiode capacitance 102c at the light sensing circuitry 102. However, the input terminal capacitance (C_{IN_OTA}) at the operational amplifier 104a continues to contribute to the noise floor of the standard light-sensing pixel 100. As the demand for light-sensing pixels 100 configured to operate in low light environments increases, there continues to be a need light-sensing pixels 100 configured to provide accurate light intensity values 112 in low light environments.

The various example embodiments described herein utilize various techniques to reduce the effect of noise on a light-sensing pixel in a low light environment. For example, in some embodiments, a light-sensing pixel may include high light read-out circuitry and low light read-out circuitry. As described herein, the high light read-out circuitry may be configured to operate in a current read-out mode, generating a light intensity value based on the current of the read-out electrical output. As further described herein, the low light read-out circuitry may be configured to operate in a voltage read-out mode, generating the light intensity value based on the voltage of the read-out electrical output.

The various example embodiments described herein further include a switching device configured to connect and disconnect the high light read-out circuitry based on the light intensity value. For example, during periods of high light intensity determined by a low/high light intensity value threshold the switching device connects the high light read-out circuitry, causing the light intensity value to be generated based on the high light read-out circuitry. However, during periods of low light intensity, the switching device disconnects the high light read-out circuitry, causing the light intensity value to be generated by the low light read-out circuitry. By disconnecting the high light read-out circuitry, the electrical devices generating noise-inducing capacitances are disconnected, enabling the light read-out circuitry configured for operation during low light to generate the light intensity value with limited noise.

Utilizing a switching device based on the light intensity received at the light sensing circuitry enables accurate light intensity values to be determined across a range of light intensities.

As a result of the herein described example embodiments and in some examples, the accuracy of a light-sensing pixel is greatly improved. In addition, by generating a light intensity value using low light read-out circuitry specifically configured for performance in low light conditions in an instance in which the light intensity is low, and high light read-out circuitry specifically configured for performance in normal and high light conditions in an instance in which the light intensity is high, the performance range of the light-sensing pixel may be increased.

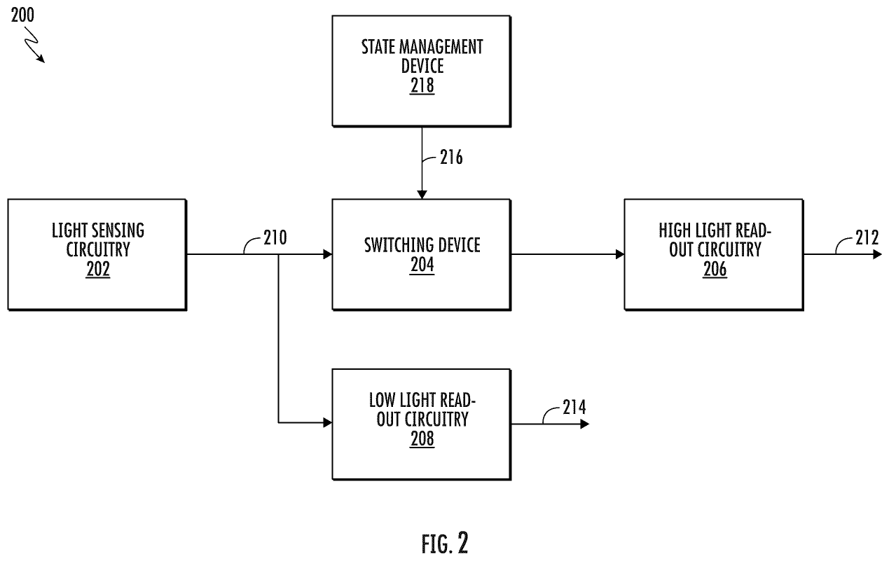

Referring now to FIG. 2, an example block diagram of a light-sensing pixel 200 is provided. As depicted in FIG. 2, the example light-sensing pixel 200 includes light sensing circuitry 202 electrically connected to a switching device 204 and low light read-out circuitry 208. The light sensing circuitry 202 configured to generate a read-out electrical output 210. As further depicted in FIG. 2, the switching device 204 is electrically connected to high light read-out circuitry 206. The high light read-out circuitry 206 (e.g., first read-out circuitry) is configured to generate a light intensity value 212 based on the current of the read-out electrical output 210, while the low light read-out circuitry 208 (e.g., second read-out circuitry) is configured to generate a light intensity value 214 based on the voltage of the read-out electrical output 210. The switching device 204 is configured to switch between a closed state and an open state based on a switching signal 216 generated by a state management device 218.

As depicted in FIG. 2, the example light-sensing pixel 200 includes light sensing circuitry 202. The light sensing circuitry 202 comprises any circuitry configured to convert photons received at a surface of the light sensing circuitry 202 into a read-out electrical output 210. The light sensing circuitry 202 includes a photodiode device. A photodiode device may comprise a photodiode, CMOS photodiode, SPAD, photodetector, or similar device. In an instance in which photons impact the photodiode device, the photons excite electrons within the photodiode device, creating an electron-hole pair. These moving charge carriers generate an output current (e.g., read-out electrical output 210) based on the number of photons impacting the photodiode device.

In some embodiments, the photodiode device comprising the light sensing circuitry 202 may be configured in a photovoltaic mode. In a photovoltaic mode, the flow of current generated by the photodiode device results in a voltage buildup. In addition, a photodiode device operating in photovoltaic mode generates less dark current compared to a photodiode device operating in a reverse-biased photodiode mode. Thus, a photodiode device operating in photovoltaic mode may be less susceptible to noise in low light environments.

As further depicted in FIG. 2, the light-sensing pixel 200 includes a switching device 204. A switching device 204 includes any electrical component configured to selectively control the flow of electricity through the switching device 204 based on the switching signal 216. A switching device 204 may include a transistor, switch, or other similar device. As depicted in FIG. 2, the switching device 204 is configured to selectively connect and disconnect the light sensing circuitry 202 to the high light read-out circuitry 206 based on the switching signal 216. In an instance in which the switching device 204 is closed, an electrical connection is made between the light sensing circuitry 202 and the high light read-out circuitry 206. In such an instance, the read-out electrical output 210 is transmitted to the high light read-out circuitry 206 and the light intensity value 212 is generated based on the current of the read-out electrical output 210. In an instance in which the switching device 204 is open, the electrical connection between the light sensing circuitry 202 and the high light read-out circuitry 206 is disconnected. In such an instance, the charge of the read-out electrical output 210 is accumulated the light intensity value 214 is determined based on the voltage of the read-out electrical output 210.

The state of the switching device 204 is determined based on the switching signal 216 as generated by the state management device 218. The switching signal 216 is any signal representing the light intensity received at the light sensing circuitry 202 compared to one or more light intensity value thresholds. For example, in some embodiments, a low light intensity value threshold (e.g., second intensity value threshold) and a high light intensity value threshold (e.g., first intensity value threshold) may be defined. The low light intensity value threshold defines the light intensity below which the switching device 204 is open and the high light read-out circuitry 206 is disconnected from receiving the read-out electrical output 210. The high light intensity value threshold defines the light intensity above which the switching device 204 is closed and the high light read-out circuitry 206 is electrically connected to the light sensing circuitry 202 to receive the read-out electrical output 210. The light intensity utilized to control the switching device 204 may include the light intensity value (e.g., light intensity value 212, 214), or any other mechanism to determine the number of photons received at or near the light sensing circuitry 202. The state management device 218 may include a controller, processor, microcontroller, comparator, hardware logic, or any device configured to monitor the light intensity relative to the one or more light intensity value thresholds and generate a switching signal 216.

In some embodiments, the low light intensity value threshold and the high light intensity value threshold may be set to different values. For example, the high light intensity value threshold may be higher than the low light intensity value threshold. Setting the high light intensity value threshold higher than the low light intensity value threshold prevents unnecessary switching by the switching device 204 in an instance in which the light intensity value is at or near one of the light intensity value thresholds.

In a non-limiting example, the low light intensity value threshold may be set to 0.1 photons per second per micrometer squared and the high light intensity value threshold set to 10 photons per second per micrometer squared. In such an example, in an instance in which the light intensity value (e.g., photon flux) at the light sensing circuitry 202 drops below 1,000,000 photons per second per micrometer squared, the switching device 204 is opened and the light intensity value 214 determined based on the voltage of the read-out electrical output 210. The switching device will remain open until the light intensity value exceeds the high light intensity value threshold. Thus, the switching device 204 may avoid unnecessary around the light intensity value thresholds. In some embodiments, the low light intensity value threshold and the high light intensity value threshold may be equal.

As further depicted in FIG. 2, the example light-sensing pixel 200 includes high light read-out circuitry 206. High light read-out circuitry 206 comprises any circuitry configured to generate a digital light intensity value 212 based on the current of the read-out electrical output 210. In some embodiments, high light read-out circuitry 206 may comprise an integrating operational amplifier configured to generate a voltage based on the current of the read-out electrical output 210. The high light read-out circuitry 206 may further include an analog-to-digital converter to convert the voltage generated by the integrating operational amplifier into a digital light intensity value 212.

The light intensity value 212 may be any data construct configured to represent a number of photons received at the light sensing circuitry 202. The light intensity value 212 may represent photon flux, light intensity, illuminance, luminous flux, and so on. In some embodiments, the light intensity value 212 may be a digital value representing the number of photons received at the light sensing circuitry 202 on a unitless scale. For example, an 8-bit digital value associating the light intensity value on a unitless scale from 0 to 255.

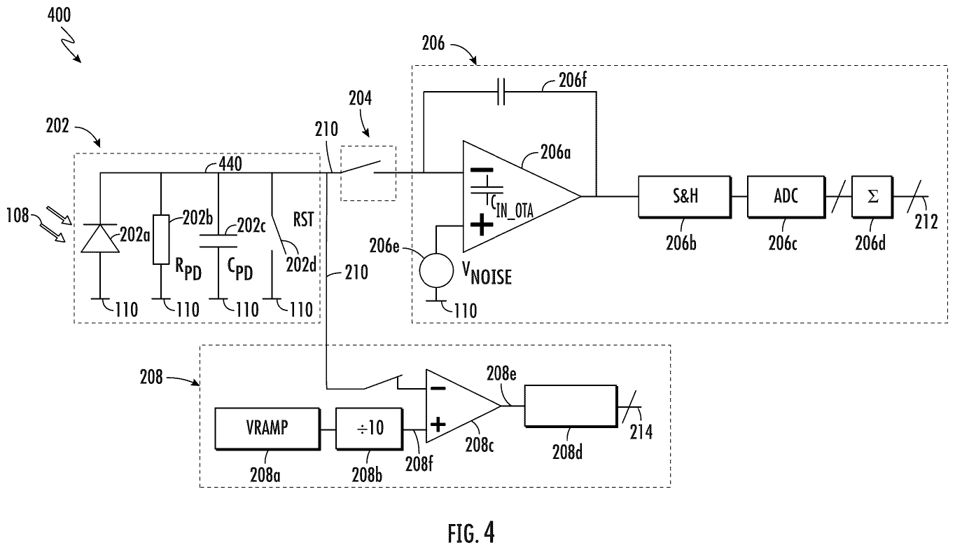

The high light read-out circuitry 206 is configured to operate in normal and/or high light environments, however, as the light intensity decreases noise within the high light read-out circuitry 206 may adversely affect the determined light intensity value 212. An example embodiment of high light read-out circuitry 206 is further described in relation to FIG. 4.

As further depicted in FIG. 2, the example light-sensing pixel 200 includes low light read-out circuitry 208. Low light read-out circuitry 208 comprises any circuitry configured to generate a digital light intensity value 214 based on the voltage of the read-out electrical output 210. In some embodiments, low light read-out circuitry 208 may determine the voltage of the read-out electrical output 210 by comparing the read-out electrical output 210 to a voltage ramp. The low light read-out circuitry 208 may further include voltage dividers and/or voltage ramp shift mechanisms to generate a voltage ramp based on the light-sensing pixel 200.

The light intensity value 214 may be any data construct configured to represent a number of photons received at the light sensing circuitry 202. The light intensity value 214 may represent photon flux, light intensity, illuminance, luminous flux, and so on. In some embodiments, the light intensity value 214 may be a digital value representing the number of photons received at the light sensing circuitry 202 on a unitless scale. For example, 8-bit digital value associating the light intensity value on a unitless scale from 0 to 255. The light-sensing pixel 200 may output the light intensity value 212 or the light intensity value 214 based on the state of the light-sensing pixel 200.

The low light read-out circuitry 208 is configured to operate in low light environments by reducing the noise present in the low light read-out circuitry 208. An example embodiment of low light read-out circuitry 208 is further described in relation to FIGS. 4, 5, and 8.

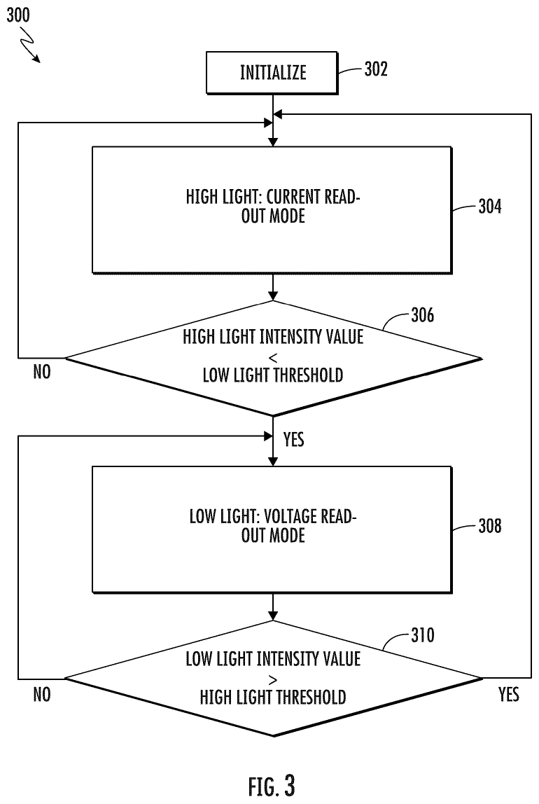

Referring now to FIG. 3, an example flow chart depicting a process 300 for determining a read-out mode to determine a light intensity value (e.g., light intensity value 212, 214) at a light-sensing pixel (e.g., light-sensing pixel 200) is depicted. The steps of the example process 300 may be performed by a state management device (e.g., state management device 218) configured to generate a switching signal (e.g., switching signal 216).

At block 302, the state management device is initialized. Initialization may include loading the state management device with one or more light intensity value thresholds (e.g., low light intensity value threshold, high light intensity value threshold). Initialization may further include setting the switching device (e.g., switching device 204) to a default mode. For example, the switching device may by default be in a closed state, thus, enabling the light-sensing pixel to operate in a current read-out mode. As depicted in FIG. 3, once initialized, operation continues at block 304.

At block 304, the switching device 204 is closed and the high light read-out circuitry (e.g., high light read-out circuitry 206) is electrically connected to the light-sensing circuitry and configured to receive the read-out electrical output (e.g., read-out electrical output 210). As described herein, the high light read-out circuitry is configured to operate in current output mode. In current output mode, the light intensity value is determined based on the current of the read-out electrical output. In some examples, the high light read-out circuitry 206 may include a charge integrator, for example, an integrating operational amplifier. The charge integrator may generate an output voltage corresponding to the current of the read-out electrical output generated by the light sensing circuitry. The high light read-out circuitry may further comprise an analog-to-digital converter configured to generate the digital light intensity value based on the output voltage of the charge integrator.

At block 306, the state management device compares a light intensity to a low light intensity value threshold. The light intensity represents the quantity of light received at the light sensing circuitry associated with the light-sensing pixel. The light intensity may be derived from any source or device configured to capture, store, and/or determine the light intensity at or near the light sensing circuitry. In some embodiments, the light intensity during current output mode is derived from the light intensity value (e.g., light intensity value 212) generated by the high light read-out circuitry. In an instance in which the light intensity is greater than the low light intensity value threshold, operation of the process 300 continues at block 304. In an instance in which the light intensity is less than the low light intensity value threshold, operation of the process 300 continues at block 308.

At block 308, the switching device 204 is open and the high light read-out circuitry is disconnected from the light-sensing circuitry. As described herein, the low light read-out circuitry is configured to operate in voltage output mode. In voltage output mode, the light intensity value is determined based on the voltage of the read-out electrical output. In voltage output mode, the voltage on the photodiode device comprising the light sensing circuitry will change. In some examples, the low light read-out circuitry includes a comparator and a single-slope ramp to generate a light intensity value based on the voltage at the photodiode device.

At block 310, the state management device compares the light intensity to a high light intensity value threshold. In some embodiments, the light intensity during voltage output mode is derived from the light intensity value (e.g., light intensity value 214) generated by the low light read-out circuitry. In an instance in which the light intensity is less than the high light intensity value threshold, operation of the process 300 continues at block 308. In an instance in which the light intensity is greater than the high light intensity value threshold, operation of the process 300 continues at block 304.

Referring now to FIG. 4, an example embodiment of a light-sensing pixel 400 is provided. As depicted in FIG. 4, the example light-sensing pixel 400 includes light sensing circuitry 202 electrically connected to a switching device 204 and low light read-out circuitry 208. The light sensing circuitry 202 configured to generate a read-out electrical output 210. As further depicted in FIG. 4, the switching device 204 is electrically connected to high light read-out circuitry 206. The high light read-out circuitry 206 is configured to generate a light intensity value 212 based on the current of the read-out electrical output 210, while the low light read-out circuitry 208 is configured to generate a light intensity value 214 based on the voltage of the read-out electrical output 210. The switching device 204 is configured to switch between a closed state and an open state based on a switching signal (e.g., depicted in FIG. 2) generated by a state management device (e.g., depicted in FIG. 2).

As depicted in FIG. 4, the light sensing circuitry 202 includes a photodiode device 202a (associated with a photodiode resistance 202b, a photodiode capacitance 202c) configured to receive photons 108, and a photodiode reset switch 202d. The anode of the photodiode device 202a, a first terminal of the photodiode resistance 202b, a first terminal of the photodiode capacitance 202c, and a first terminal of the photodiode reset switch 202d are all electrically connected to electrical ground 110. The cathode of the photodiode device 202a, a second terminal of the photodiode resistance 202b, a second terminal of the photodiode capacitance 202c, and a second terminal of the photodiode reset switch 202d are all electrically connected to the output conductor 440 of the light sensing circuitry 202. The output conductor 440 is configured to carry the read-out electrical output 210. In some embodiments, the light sensing circuitry 202 may comprise a three transistor (3T) pixel architecture. The 3T pixel architecture may enable a lower photodiode capacitance 202c resulting in a higher conversion gain.

As depicted in FIG. 4, during current read-out mode, in which the high light read-out circuitry 206 is electrically connected to the output conductor 440, the current generated by the photodiode device 202a is transmitted to the operational amplifier 206a of the high light read-out circuitry 206 and a voltage is generated based on the current. However, during the voltage read-out mode, in which the high light read-out circuitry 206 is disconnected from the output conductor 440, the photodiode is in a photovoltaic mode in which charge is accumulated at the photodiode capacitance 202c. The charge at the photodiode capacitance 202c may be received at the inverting port of the comparator 208c of the low light read-out circuitry 208. The voltage of the read-out electrical output 210 may be determined by the low light read-out circuitry 208. In addition, the photodiode reset switch 202d may be closed at the start of the voltage read-out mode, biasing the voltage on the output conductor 440 to 0. By biasing the voltage on the output conductor 440 to 0, the dark current generated by the photodiode device 202a may be reduced.

As further depicted in FIG. 4, the high light read-out circuitry 206 includes an integrating operational amplifier 206a comprising an inverting input (−), a non-inverting input (+), and an output port. The output port is electrically connected to the inverting port (−) on an electrical path including a feedback capacitor 206f. The inverting input (−) of the operational amplifier 206a is further electrically connected to the switching device 204 and configured to receive the read-out electrical output 210 from the light sensing circuitry 102 in an instance in which the switching device 204 is closed. The non-inverting input (+) of the operational amplifier 206a is electrically connected to the electrical ground 110. As further depicted in FIG. 4, the operational amplifier 206a is configured in an integration mode. Thus, the voltage output of the operational amplifier 206a is proportional to the current of the read-out electrical output 210. The noise source 206e depicted in FIG. 4, illustrates the role of noise in the determination of the light intensity value 212 using the high light read-out circuitry 206. Any noise in the light sensing circuitry 202 and high light read-out circuitry 206 is amplified by the operational amplifier 206a during the generation of an output voltage based on the current of the read-out electrical output 210.

As further depicted in FIG. 4, the output of the operational amplifier 206a is electrically connected to an input of a sample and hold circuit 206b. In addition, the output of the sample and hold circuit 206b is electrically connected to the input of an analog-to-digital converter 206c. Further, the high light read-out circuitry 206 includes summation circuitry 206d electrically connected to the output of the analog-to-digital converter 206c and configured to generate a digital light intensity value 212 based on the output of the analog-to-digital converter 206c. The sample and hold circuit 206b, analog-to-digital converter 206c, and summation circuitry 206d are configured to generate a digital light intensity value 212 based on the output voltage from the operational amplifier 104a.

As further depicted in FIG. 4, the low light read-out circuitry 208 includes a comparator 208c comprising an inverting input (−), a non-inverting input (+), and an output. The inverting input (−) of the comparator 208c is electrically connected to the output conductor 440 of the light sensing circuitry 202 and configured to receive the read-out electrical output 210. The non-inverting input (+) of the comparator 208c is configured to receive a voltage ramp 208f. The comparator 208c has a lower input capacitance compared to the capacitances associated with the high light read-out circuitry 206. Thus, the low light read-out circuitry 208 exhibits less noise in the light intensity value and is configured for accurate operation, particularly in low light environments. In addition, there is no feedback in the comparator 208c, meaning no noise amplification at the comparator 208c.

As depicted in FIG. 4, the voltage ramp 208f is a voltage divided derivative of a system ramp voltage. In some embodiments, the voltage range of the system voltage ramp may be too large for the potential voltages output by the light sensing circuitry 202 in photovoltaic mode. For example, the voltage ramp may be between 0 volts and 1 volts, while the voltage range of the read-out electrical output 210 is between 0 and 0.1 volts. Thus, a voltage divided derivative of the voltage ramp may enable more accurate voltages to be determined. As depicted in FIG. 4, the system ramp voltage is generated by a system ramp voltage source 208a and received by an electrically connected voltage divider 208b. The voltage divider 208b generates the voltage divided derivative of the system ramp voltage. The voltage divided derivative voltage may be transmitted to the non-inverting input (+) of the comparator 208c as the voltage ramp 208f.

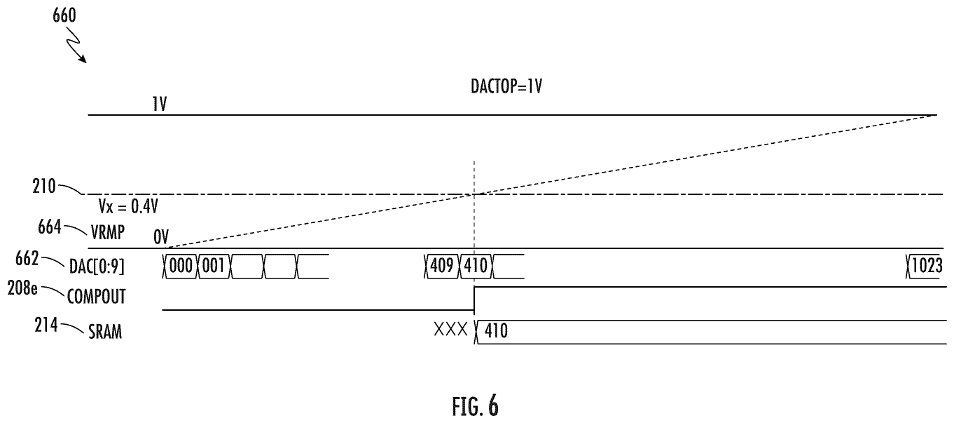

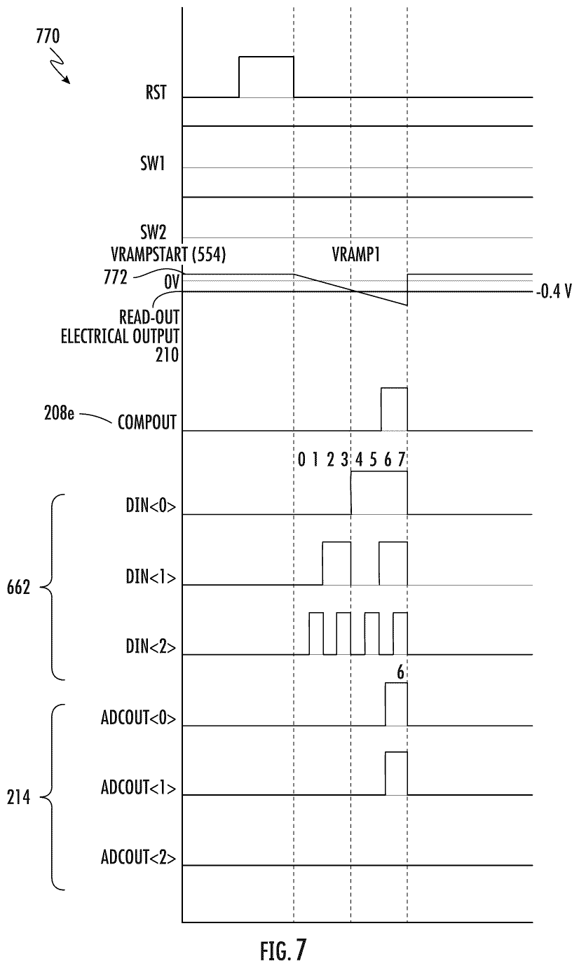

As further depicted in FIG. 4, the comparator 208c is electrically connected to a memory device 208d. The comparator 208c is configured to indicate a match on the comparator out signal 208e in an instance in which the voltage of the read-out electrical output 210 matches the voltage ramp 208f. The comparator out signal 208e causes the voltage of the read-out electrical output 210 to be written to the memory device 208d. Thus, the light intensity value 214 may be stored and transmitted by a comparison to the voltage ramp 208f. The determination of the light intensity value 214 based on a voltage ramp 208f is further described in relation to FIG. 6-FIG. 7. In some embodiments, the memory device 208d may include a counter. For example, a counter may be reset at the start of the conversion, clocked at the same frequency as the system ramp voltage source 208a (or in an integer relationship) and stopped by the comparator signal 208e to store the voltage of the read-out electrical output 210.

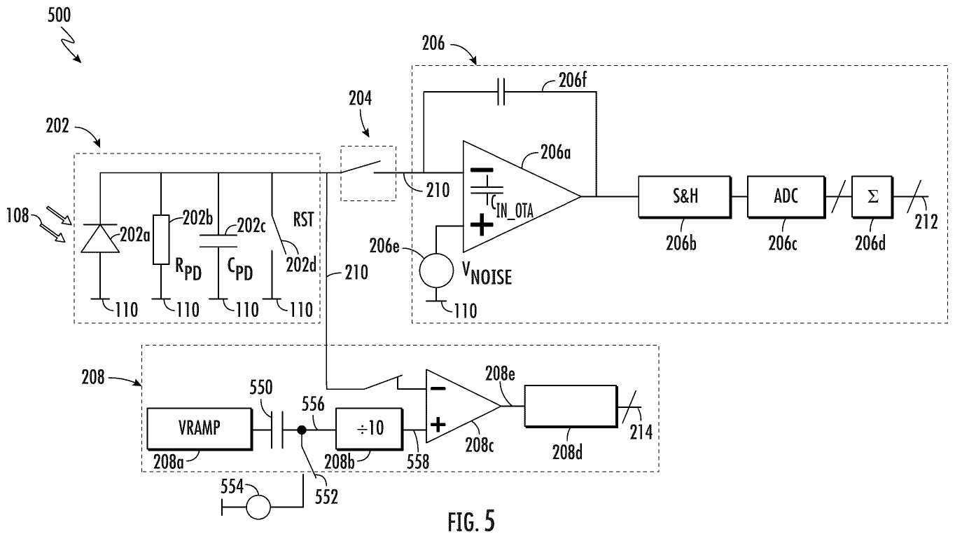

Referring now to FIG. 5, an example embodiment of a light-sensing pixel 500 is provided. As depicted in FIG. 5, the example light-sensing pixel 500 includes light sensing circuitry 202 electrically connected to a switching device 204 and low light read-out circuitry 208. The light sensing circuitry 202 configured to generate a read-out electrical output 210. As further depicted in FIG. 5, the switching device 204 is electrically connected to high light read-out circuitry 206. The high light read-out circuitry 206 is configured to generate a light intensity value 212 based on the current of the read-out electrical output 210, while the low light read-out circuitry 208 is configured to generate a light intensity value 214 based on the voltage of the read-out electrical output 210. The switching device 204 is configured to switch between a closed state and an open state based on a switching signal (e.g., depicted in FIG. 2) generated by a state management device (e.g., depicted in FIG. 2).

As depicted in FIG. 5, the light sensing circuitry 202 includes a photodiode device 202a (associated with a photodiode resistance 202b, a photodiode capacitance 202c) configured to receive photons 108, and a photodiode reset switch 202d. The anode of the photodiode device 202a, a first terminal of the photodiode resistance 202b, a first terminal of the photodiode capacitance 202c, and a first terminal of the photodiode reset switch 202d are all electrically connected to electrical ground 110. The cathode of the photodiode device 202a, a second terminal of the photodiode resistance 202b, a second terminal of the photodiode capacitance 202c, and a second terminal of the photodiode reset switch 202d are all electrically connected to the output conductor 440 of the light sensing circuitry 202. The output conductor 440 is configured to carry the read-out electrical output 210. In some embodiments, the light sensing circuitry 202 may comprise a three transistor (3T) pixel architecture. The 3T pixel architecture may enable a lower photodiode capacitance 202c resulting in a higher conversion gain.

In an instance in which the switching device 204 is in a closed state, the high light read-out circuitry 206 is electrically connected to the output conductor 440 and configured to operate in a current read-mode. For example, as in FIG. 5, the high light read-out circuitry 206 includes an integrating operational amplifier 206a comprising an inverting input (−), a non-inverting input (+), and an output port. The output port is electrically connected to the inverting port (−) on an electrical path including a feedback capacitor 206f. The inverting input (−) of the operational amplifier 206a is further electrically connected to the switching device 204. The non-inverting input (+) of the operational amplifier 206a is electrically connected to the electrical ground 110.

As further depicted in FIG. 5, the output of the operational amplifier 206a is electrically connected to an input of a sample and hold circuit 206b. In addition, the output of the sample and hold circuit 206b is electrically connected to the input of an analog-to-digital converter 206c. Further, the output of the sample and hold circuit 206b is electrically connected to the input of the analog-to-digital converter 206c, and the output of the analog-to-digital converter 206c is electrically connected to the input of the summation circuitry 206d. The summation circuitry 206d is configured to generate a digital light intensity value 212 based on the output from the analog-to-digital converter 206c.

As further depicted in FIG. 5, the low light read-out circuitry 208 includes a comparator 208c comprising an inverting input (−), a non-inverting input (+), and an output. The inverting input (−) of the comparator 208c is electrically connected to the output conductor 440 of the light sensing circuitry 202 and configured to receive the read-out electrical output 210. The non-inverting input (+) of the comparator 208c is configured to receive a voltage ramp 558.

As further depicted in FIG. 5, the comparator out signal 208e of the comparator 208c causes the voltage of the read-out electrical output 210 to be written to a memory device 208d in an instance in which the voltage of the read-out electrical output 210 matches the voltage ramp 558. Thus, the light intensity value 214 may be stored and transmitted from the memory device 208d. The determination of the light intensity value 214 based on a voltage ramp 558 is further described in relation to FIG. 6-FIG. 7.

As depicted in FIG. 5, the voltage ramp 558 is a voltage divided and shifted derivative of a system ramp voltage. As described in relation to FIG. 4, in some embodiments, a voltage divided derivative of the system voltage ramp may enable determination of accurate voltage readings of the read-out electrical output 210. In addition, as shown in FIG. 5, in some embodiments, a shifted derivative voltage of the system voltage ramp may be necessary. For example, a shifted derivative voltage may enable generation of a negative voltage ramp based on a positive voltage ramp. As depicted in FIG. 5, a voltage ramp shifting capacitor 550 is electrically connected between the system ramp voltage source 208a and the voltage divider 208b. In addition, a reset switch 552 electrically connects a voltage ramp start voltage 554 to the second terminal 556 of the voltage ramp shifting capacitor 550 opposite the system ramp voltage source 208a. On reset, the reset switch 552 closes, enabling transmission of the voltage ramp start voltage 554 to the second terminal 556 of the voltage ramp shifting capacitor 550. Since the system ramp voltage source 208a is AC coupled to the voltage ramp shifting capacitor 550, once the reset switch 552 is opened, the voltage at the second terminal 556 tracks the system voltage ramp received at the first terminal of the voltage ramp shifting capacitor 550. For example, in an instance in which the voltage ramp start voltage 554 is 10 millivolts, upon reset, the second terminal 556 of the voltage ramp shifting capacitor 550 is set to 10 millivolts. Further, in an instance in which the system voltage ramp progresses from 200 millivolts, down to 0 millivolts, the voltage at the second terminal 556 of the voltage ramp shifting capacitor 550 similarly progresses from a voltage of 10 millivolts (e.g., voltage ramp start voltage 554) down to −190 millivolts. Thus, a shifted derivative of the system voltage ramp comprising negative voltages is provided to the voltage divider 208b.

Referring now to FIG. 6, an example process 660 for determining a voltage of a read-out electrical output 210 using a system ramp voltage source 208a and a comparator (e.g., comparator 208c) is depicted. As shown herein, a voltage ramp 664 (e.g., voltage ramp 208f, voltage ramp 558) and the read-out electrical output 210 are provided to the two inputs of a comparator. Although the voltage ramp 664 is depicted having a positive slope, the voltage ramp 664 may comprise any slope in any direction. The comparator is configured to generate a comparator out signal (e.g., comparator out signal 208e) based on the comparison of the voltage ramp 664 to the read-out electrical output 210. In an instance in which the voltage ramp 664 is greater than or equal to the read-out electrical output 210, the comparator out signal 208e is updated, for example, to a logical high output. In addition, a voltage count 662 is incremented in synchronization with the voltage ramp 664. The voltage count 662 is a digital representation of a voltage value. In an instance in which the comparator out signal 208e updates to a logical high output, the value in the voltage count 662 is written to the memory device 208d. Thus, the stored voltage count 662 in the memory device 208d may be read as the light intensity value 212.

Referring now to FIG. 7, a signal diagram 770 determining a read-out electrical output 210 voltage based on a shifted voltage ramp 772 (e.g., shifted voltage ramp 558) is provided. As depicted in FIG. 7, the shifted voltage ramp 772 begins at the voltage ramp start voltage 554 and declines. As further depicted in FIG. 7, the voltage count 662 begins to increment. In an instance in which the shifted voltage ramp 772 is less than or equal to the voltage at the comparator (read-out electrical output 210) the comparator out signal 208e is asserted to a logic high. When the comparator out signal 208e is asserted, the voltage count 662 (e.g., 6) is written to the memory device and may be read as the light intensity value 212.

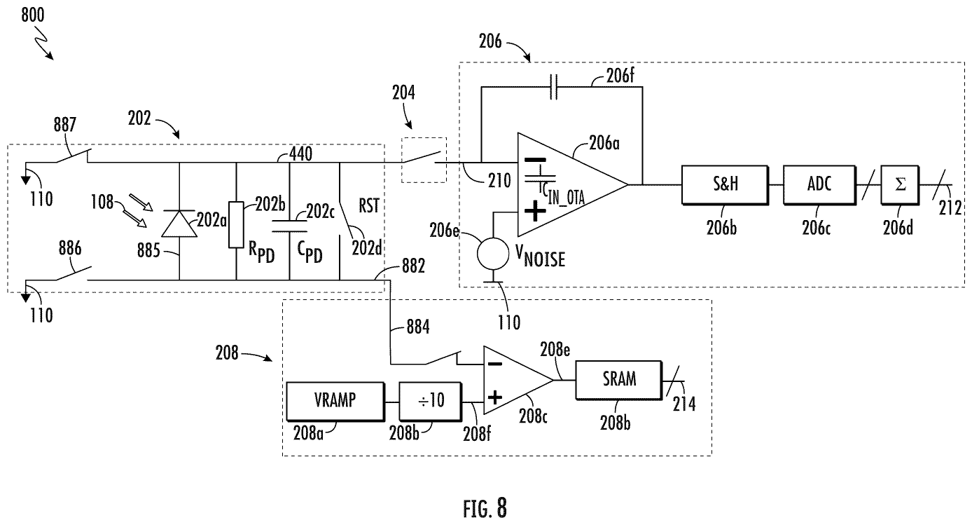

Referring now to FIG. 8, an example embodiment of a light-sensing pixel 800 is provided. As depicted in FIG. 8, the example light-sensing pixel 800 includes light sensing circuitry 202 comprising two outputs, output conductor 440 electrically connected to a switching device 204, and output conductor 882 electrically connected to the low light read-out circuitry 208. The light sensing circuitry 202 configured to generate a first read-out electrical output 210 and a second read-out electrical output 884. As further depicted in FIG. 8, the switching device 204 is electrically connected to high light read-out circuitry 206. The high light read-out circuitry 206 is configured to generate a light intensity value 212 based on the current of the read-out electrical output 210, while the low light read-out circuitry 208 is configured to generate a light intensity value 214 based on the voltage of the second read-out electrical output 884. The switching device 204 is configured to switch between a closed state and an open state based on a switching signal (e.g., depicted in FIG. 2) generated by a state management device (e.g., depicted in FIG. 2).

As depicted in FIG. 8, the light sensing circuitry 202 includes a photodiode device 202a configured to receive photons 108, a photodiode resistance 202b, a photodiode capacitance 202c, and a photodiode reset switch 202d. The anode 885 of the photodiode device 202a, a first terminal of the photodiode resistance 202b, a first terminal of the photodiode capacitance 202c, and a first terminal of the photodiode reset switch 202d are all electrically connected to the output conductor 882. The output conductor 882 is configured to carry the second read-out electrical output 884. By generating the second read-out electrical output 884 from the anode 885 of the photodiode device 202a, the number of photons 108 received at the photodiode device 202a may be represented by a positive voltage on the second read-out electrical output 884.

As further depicted in FIG. 8, two additional switches (switch 886, 887) have been added. A first switch 886 electrically connected between the photodiode anode 885 and an electrical ground 110, and a second switch 887 electrically connected between the photodiode cathode and the electrical ground 110. The first switch 886 may be opened and closed in coordination with the switching device 204, while the second switch 887 is held in an opposite state to the first switch 886.

The cathode of the photodiode device 202a, a second terminal of the photodiode resistance 202b, a second terminal of the photodiode capacitance 202c, and a second terminal of the photodiode reset switch 202d are all electrically connected to the output conductor 440 of the light sensing circuitry 202. The output conductor 440 is configured to carry the read-out electrical output 210. In some embodiments, the light sensing circuitry 202 may comprise a three transistor (3T) pixel architecture. The 3T pixel architecture may enable a lower photodiode capacitance 202c resulting in a higher conversion gain.

In an instance in which the switching device 204 and the additional switch 886 are in a closed state, the high light read-out circuitry 206 is electrically connected to the output conductor 440 and configured to operate in a current read-mode. For example, as in FIG. 8, the high light read-out circuitry 206 includes an integrating operational amplifier 206a comprising an inverting input (−), a non-inverting input (+), and an output port. The output port is electrically connected to the inverting port (−) on an electrical path including a feedback capacitor 206f. The inverting input (−) of the operational amplifier 206a is further electrically connected to the switching device 204. The non-inverting input (+) of the operational amplifier 206a is electrically connected to the electrical ground 110.

As further depicted in FIG. 8, the output of the operational amplifier 206a is electrically connected to an input of a sample and hold circuit 206b. In addition, the output of the sample and hold circuit 206b is electrically connected to the input of an analog-to-digital converter 206c. Further, the output of the sample and hold circuit 206b is electrically connected to the input of the analog-to-digital converter 206c, and the output of the analog-to-digital converter 206c is electrically connected to the input of the summation circuitry 206d. The summation circuitry 206d is configured to generate a digital light intensity value 212 based on the output from the analog-to-digital converter 206c.

As further depicted in FIG. 8, the low light read-out circuitry 208 includes a comparator 208c comprising an inverting input (−), a non-inverting input (+), and an output. The inverting input (−) of the comparator 208c is electrically connected to the output conductor 882 of the light sensing circuitry 202 and configured to receive the second read-out electrical output 884. The non-inverting input (+) of the comparator 208c is configured to receive a voltage ramp 208f. The voltage ramp 208f is a voltage divided derivative of a system ramp voltage generated by a system ramp voltage source 208a and voltage divided by a voltage divider 208b.

As further depicted in FIG. 8, the comparator out signal 208e of the comparator 208c causes the voltage of the second read-out electrical output 884 to be written to a memory device 208d in an instance in which the voltage of the second read-out electrical output 884 matches the voltage ramp 208f. Thus, the light intensity value 214 may be stored and transmitted from the memory device 208d. The determination of the light intensity value 214 based on a voltage ramp 208f is further described in relation to FIG. 6-FIG. 7. In some embodiments, the memory device 208d may include a counter. For example, a counter may be reset at the start of the conversion, clocked at the same frequency as the system ramp voltage source 208a (or in an integer relationship) and stopped by the comparator signal 208e to store the voltage of the read-out electrical output 210.

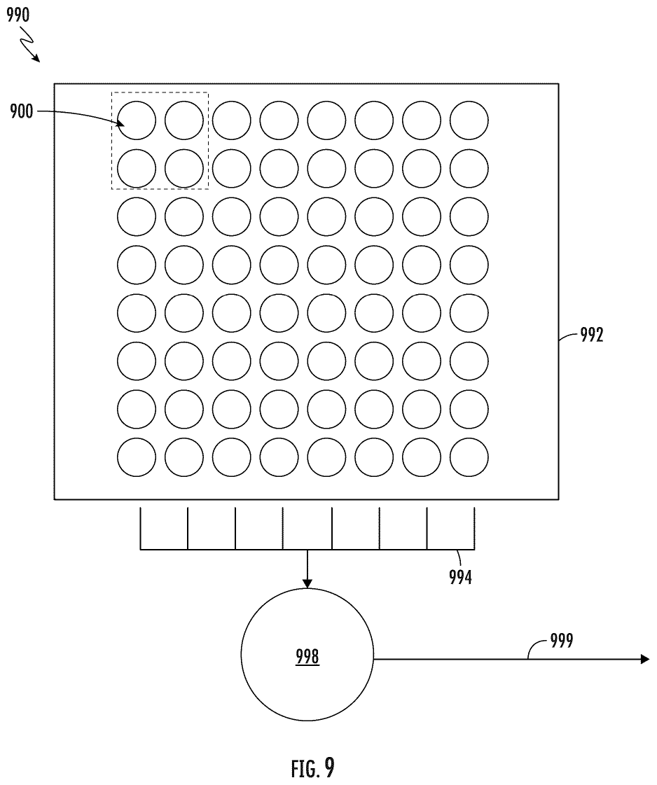

Referring now to FIG. 9, an example ambient light sensor 990 comprising an array of light-sensing pixels 992 (e.g., light-sensing pixel 200, 400, 500, 800) is provided. As depicted in FIG. 9, the example ambient light sensor 990 includes column read-out circuitry 994 configured to transmit the light intensity value from each light-sensing pixel 900 comprising the array of light-sensing pixels 992 to pixel accumulator circuitry 998.

The pixel accumulator circuitry 998 comprises any circuitry including hardware and/or software configured to accumulate the ambient light values generated by each of the light-sensing pixels 900. In some embodiments, the pixel accumulator circuitry 998 accumulates ambient light values over a period of time. Pixel accumulator circuitry 998 may generate a total ambient light value 999 based on the accumulated ambient light values. The total ambient light value 999 comprises any data construct representing the amount of light received at the array of light-sensing pixels 992 as determined by the ambient light values generated by each of the light-sensing pixels 900. For example, the total ambient light value 999 may comprise an average, sum, or other data representation of the light received at the array of light-sensing pixels 992.

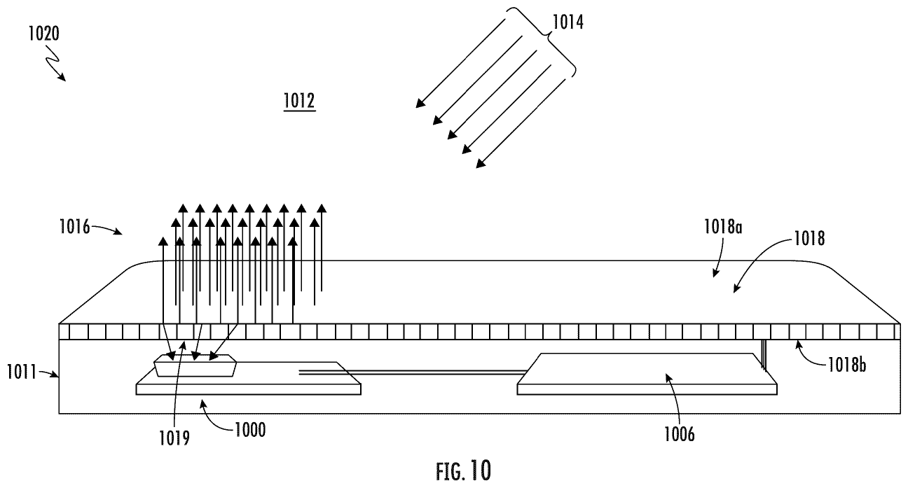

Referring now to FIG. 10, an example electronic device 1020 comprising an ambient light sensor 1000 is provided. As depicted in FIG. 10, the example electronic device 1020 includes a housing 1011 and a display screen 1018 defining an enclosed area in which the ambient light sensor 1000 and a controller 1006 are disposed. The controller 1006 is electrically coupled to the ambient light sensor 1000 to receive at least total ambient light values (e.g., total ambient light value 999). The controller 1006 is further electrically connected to the display screen 1018.

As further depicted in FIG. 10, the example electronic device 1020 includes a housing 1011. The housing 1011 may be any structure, packaging, case, or similar mechanism designed to provide a protective enclosure for the internal components of the electronic device 1020, for example, including the ambient light sensor 1000. In some embodiments, the housing 1011 together with the display screen 1018 define an enclosed area.

As further depicted in FIG. 10, the display screen 1018 comprises a first side 1018a configured to emit transmitted light 1016 via a plurality of display pixels 1019 into the external environment 1012 and a second side 1018b opposite the first side 1018a. During refresh of the display screen 1018, a continuously updating portion of the display pixels 1019 are unlit.

As further depicted in FIG. 10, the example electronic device 1020 includes a housing 1011 wherein a portion of the housing 1011 includes a display screen 1018. As further depicted in FIG. 10, the electronic device 1020 includes an ambient light sensor 1000 for purposes of determining an ambient light value associated with the ambient light 1014 present in an external environment 1012. In some non-limiting examples, the electronic device 1020 may comprise a mobile phone, laptop, television, monitor, computer, wearable electronic device, or other mobile device.

As further depicted in FIG. 10, the electronic device 1020 includes a display screen 1018 comprising a plurality of display pixels 1019 configured to emit transmitted light 1016. A display screen 1018 may be any digital display, screen, monitor, or other device configured to output information in visual form via transmitted light 1016 based on a received electronic signal. A display screen 1018 may be transparent or semi-transparent to certain wavelengths of light, such that ambient light 1014 may be received by an ambient light sensor 1000 behind or under the display screen 1018. In some non-limiting examples, the display screen 1018 may comprise an organic light-emitting diode (OLED) display, active-matrix OLED (AMOLED) display, or other similar variation.

In some embodiments, the display screen 1018 may comprise a plurality of display pixels 1019. Display pixels 1019 are the smallest unit of display in a display screen 1018. A display pixel 1019 may be configured to output an intensity of light or a combination of light intensities based on an electronic signal indicating a desired output. For example, in some embodiments, each display pixel 1019 of a display screen 1018 may emit a red, green, and blue color at different intensities to generate a specific color from the display pixel 1019.

The plurality of display pixels 1019 may be illuminated in a coordinated manner to generate a display image. For example, in some embodiments, the display pixels 1019 may be refreshed one row at a time and move sequentially from one side of the display to the other. Due to the speed of refresh, the display screen 1018 may appear to be fully illuminated. During the refresh process, one or more rows of unlit display pixels may move from the top of the display screen 1018 to the bottom of the display screen 1018. In an instance in which the ambient light sensor 1000 is positioned within the housing 1011 and under the display screen 1018, during the refresh of the display screen 1018, a row and/or rows of display pixels 1019 directly above the ambient light sensor 1000 may be unlit for a period of time. In some embodiments, the exposure window of the ambient light sensor 1000 may be timed such that the light intensity values (e.g., light intensity value 212, 214) are determined and accumulated and/or aggregated as the total ambient light value (e.g., total ambient light value 999) in the instances in which the unlit display pixels of the display screen 1018 are directly or partially above the ambient light sensor 1000. Timing the exposure windows with the refresh of the display screen 1018 enables the ambient light sensor 1000 to better isolate the ambient light 1014 in the external environment 1016.

In some embodiments, the electronic device 1020 is configured to adjust various settings of the electronic device 1020 or a connected component based on the total ambient light value determined by the ambient light sensor 1000 and controller. For example, capture settings of a digital camera may be adjusted based on the ambient light value indicating the amount of ambient light 1014 in the external environment 1012. Similarly, display screen 1018 settings of a mobile device (e.g., screen brightness) may be adjusted based on the ambient light 1014 in the external environment 1012 in which the display screen 1018 is viewed.

While this detailed description has set forth some embodiments of the present invention, the appended claims cover other embodiments of the present invention which differ from the described embodiments according to various modifications and improvements. For example, one skilled in the art may recognize that such principles may be applied to any light sensing device that utilizes photodiode devices to determine a light intensity value in an external environment. For example, ambient light sensors, image sensors, ranging sensors, and so on.

Within the appended claims, unless the specific term “means for” or “step for” is used within a given claim, it is not intended that the claim be interpreted under 35 U. S. C. 112, paragraph 6.

Use of broader terms such as “comprises,” “includes,” and “having” should be understood to provide support for narrower terms such as “consisting of,” “consisting essentially of,” and “comprised substantially of” Use of the terms “optionally,” “may,” “might,” “possibly,” and the like with respect to any element of an embodiment means that the element is not required, or alternatively, the element is required, both alternatives being within the scope of the embodiment(s). Also, references to examples are merely provided for illustrative purposes, and are not intended to be exclusive.

1. A light-sensing pixel, comprising:
light sensing circuitry configured to generate a read-out electrical output based on a quantity of photons received at a photodiode device;
first read-out circuitry configured to generate a light intensity value based on a current of the read-out electrical output;
second read-out circuitry electrically connected to the read-out electrical output and configured to generate the light intensity value based on a voltage of the read-out electrical output; and
a switching device configured to electrically disconnect the first read-out circuitry from the light sensing circuitry based on the light intensity value.

2. The light-sensing pixel of claim 1, wherein the first read-out circuitry comprises an operational amplifier and an analog-to-digital converter.

3. The light-sensing pixel of claim 2, wherein the read-out electrical output is electrically connected to an inverting input of the operational amplifier.

4. The light-sensing pixel of claim 1, wherein the light sensing circuitry comprises a three transistor (3T) pixel architecture.

5. The light-sensing pixel of claim 1, wherein the second read-out circuitry determines the voltage of the read-out electrical output by comparison to a voltage ramp.

6. The light-sensing pixel of claim 5, wherein the second read-out circuitry comprises a comparator and a memory device.

7. The light-sensing pixel of claim 6, wherein an inverting input of the comparator is electrically connected to the read-out electrical output and a non-inverting input is electrically connected to the voltage ramp.

8. The light-sensing pixel of claim 7, wherein the voltage ramp comprises a voltage divided derivative of a system ramp voltage.

9. The light-sensing pixel of claim 8, wherein the voltage divided derivative of the system ramp voltage is determined locally at the second read-out circuitry.

10. The light-sensing pixel of claim 8, wherein the voltage ramp comprises a shifted derivative of the system ramp voltage.

11. The light-sensing pixel of claim 1, wherein the second read-out circuitry is electrically connected to an anode of the photodiode device.

12. The light-sensing pixel of claim 1, wherein the first read-out circuitry comprises high light read-out circuitry, and wherein the second read-out circuitry comprises low light read-out circuitry.

13. An ambient light sensor, comprising:
a plurality of light-sensing pixels, each light sensing pixel comprising:
light sensing circuitry configured to generate a read-out electrical output based on a quantity of photons received at a photodiode device;
first read-out circuitry configured to generate a light intensity value based on a current of the read-out electrical output;
second read-out circuitry configured to generate the light intensity value based on a voltage of the read-out electrical output; and
a switching device configured to electrically disconnect the first read-out circuitry from the light sensing circuitry based on the light intensity value; and
pixel accumulation circuitry configured to generate an ambient light value based on the light intensity value of each light-sensing pixel of the plurality of light-sensing pixels.

14. The ambient light sensor of claim 12, wherein the first read-out circuitry comprises an operational amplifier and an analog-to-digital converter, and wherein the read-out electrical output is electrically connected to an inverting input of the operational amplifier.

15. The ambient light sensor of claim 12, wherein the light sensing circuitry comprises a three transistor (3T) pixel architecture.

16. The ambient light sensor of claim 12, wherein the second read-out circuitry determines the voltage of the read-out electrical output by comparison to a voltage ramp.

17. The ambient light sensor of claim 16, wherein the second read-out circuitry comprises a comparator and a memory device.

18. The ambient light sensor of claim 17, wherein an inverting input of the comparator is electrically connected to the read-out electrical output and a non-inverting input is electrically connected to the voltage ramp.

19. The ambient light sensor of claim 12, wherein the second read-out circuitry is electrically connected to an anode of the photodiode device.

20. A method for generating a light intensity value at an ambient light sensor, the method comprising:
generating, at light sensing circuitry, a read-out electrical output based on a quantity of photons received at a photodiode device;
determining a switching state of a switching device based on the quantity of photons received at the photodiode device;
updating the switching device based on the switching state, wherein:
in a first switching state, the first read-out circuitry is electrically connected to the light sensing circuitry and the light intensity value is generated by the first read-out circuitry; and
in a second switching state, the first read-out circuitry is electrically disconnected from the light sensing circuitry and the light intensity value is generated by the second read-out circuitry.
